(19) United States
(12) Patent Application Publication
(10) Pub. No.: US 2016/0124625 A1
(43) Pub. Date: May 5, 2016

(54) METHOD AND SYSTEM FOR AUTOMATICALLY SIZING WINDOWS IN RESPONSE TO USER ACTIONS

(71) Applicant: THOMSON LICENSING, Issy Les Moulineaux (FR)

(72) Inventor: Regine LAWTON, Thousand Oaks, CA (US)

(21) Appl. No.: 14/897,743

(22) PCT Filed: Jun. 14, 2013
(86) PCT No.: PCT/US2013/045857

§ 371 Date: Dec. 11, 2015

(51) Int. Cl. G06F 3/0484; G06F 3/0482

(52) U.S. Cl. CPC G06F 3/04847; G06F 3/0482

(57) ABSTRACT

A method includes determining a size of a particular window displayed on a display screen and a number of content options for a respective content category displayed in the particular window. The size and the number of content options are determined responsive to an indication of user preferences for the respective content category. The method further includes displaying multiple windows, including the particular window, with each of the multiple windows corresponding to a respective one of different content categories. The particular window is displayed with the determined size and determined number of content options. The method also includes accessing an updated indication. The updated indication reflects observed user behavior. The method additionally includes modifying a size of at least one of the multiple windows and the number of content choices displayed therein responsive to the updated indication.

### TECHNICAL FIELD

The present principles relate generally to user interfaces and, more particularly, to a method and system for automatically sizing windows in response to user actions.

### BACKGROUND

The consumption of digital content by consumers is ever increasing. The pervasiveness of mobile media devices has served to increase such consumption. However, user preferences are not factored into the presentation of the digital content in a manner most favorable to the user.

### SUMMARY

These and other drawbacks and disadvantages of the prior art are addressed by the present principles, which are directed to a method and system for automatically sizing windows in response to user actions.

According to an aspect of the present principles, there is provided a method. The method includes determining a size of at least one window displayed on a display screen and a number of content options for a respective one of different content categories displayed in the at least one window. The size and the number of content options are determined responsive to an indication of user preferences for the respective content categories, such that the size of the at least one window and the number of content options displayed therein increases responsive to an increasing level of user preference for a corresponding one of the respective content categories. The method further includes displaying on the display screen multiple windows, including the at least one window, with each of the multiple windows corresponding to a respective one of the different content categories. The at least one window is displayed with the determined size and the determined number of content options. The method also includes accessing an updated indication of the user preferences for the respective content categories from a memory device. The updated indication reflects observed user behavior. The method additionally includes modifying a size of at least one of the multiple windows and the number of content choices displayed therein responsive to the updated indication.

According to another aspect of the present principles, there is provided a system in a media presentation device. The system includes a window layout manager for determining a size of at least one window and a number of content options for a respective one of different content categories displayed in the at least one window. The size and the number of content options are determined responsive to an indication of user preferences for the respective content categories, such that the size of the at least one window and the number of content options displayed therein increases responsive to an increasing level of user preference for a corresponding one of the respective content categories. The system further includes a display screen for displaying multiple windows, including the at least one window, with each of the multiple windows corresponding to a respective one of the different content categories. The at least one window is displayed with the determined size and the determined number of content options. The window layout manager accesses an updated indication of the user preferences for the respective content categories and modifies a size of at least one of the multiple windows and the number of content choices displayed therein responsive to the updated indication. The updated indication reflects observed user behavior.

According to yet another embodiment of the present principles, there is provided a non-transitory computer readable storage medium having computer executable code stored thereon for performing a method. The method includes determining a size of at least one window displayed on a display screen and a number of content options for a respective one of different content categories displayed in the at least one window. The size and the number of content options are determined responsive to an indication of user preferences for the respective content categories, such that the size of the at least one window and the number of content options displayed therein increases responsive to an increasing level of user preference for a corresponding one of the respective content categories. The method further includes displaying on the display screen multiple windows, including the at least one window, with each of the multiple windows corresponding to a respective one of the different content categories. The at least one window is displayed with the determined size and the determined number of content options. The method also includes accessing an updated indication of the user preferences for the respective content categories from a memory device. The updated indication reflects observed user behavior. The method additionally includes modifying a size of at least one of the multiple windows and the number of content choices displayed therein responsive to the updated indication. These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for automatically sizing windows in response to user actions, in accordance with an embodiment of the present principles;

FIG. 4 shows an exemplary method 400 for automatically sizing windows in response to user actions, in accordance with an embodiment of the present principles;

FIG. 5 shows an exemplary user interface 500 having different cards 510 depicted thereon, in accordance with an embodiment of the present principles;

FIG. 6 shows a modified version 600 of the user interface 500 of FIG. 5, in accordance with an embodiment of the present principles; and

FIG. 7 shows another modified version 700 of the user interface 500 of FIG. 5, in accordance with an embodiment of the present principles.

### DETAILED DESCRIPTION

The present principles are directed to a method and system for automatically sizing windows in response to user actions. It is to be appreciated that the terms “windows”, “cards”, and “menus” are used interchangeably herein to refer to bounded regions on a display screen. In an embodiment, the bounded regions correspond to different content categories and can include a listing of content choices therein.

In an embodiment, the present principles advantageously provide an automatic way of resizing various windows presented to a user. Typically, when a listing of windows is shown to a user, such windows are always the same size. In an embodiment, the present principles alter this approach to automatically adjust graphical elements to reflect a user's preferences that are determined in view of a profile.

In an embodiment, the present principles are used with respect to digital content provided by a digital content service provider. In an embodiment, the digital service provider operates over a content platform that enables consumers to easily locate, view and share content from, for example, over-the-top (OTT), operator, and local networks. Of course, other network types can be used, while maintaining the spirit of the present principles. In an embodiment, the present principles are implemented with respect to a digital content service provider/system such as, for example, M-Go™/MediaNavi™. Of course, the present principles can be used with respect to other digital content service providers/systems while maintaining the spirit of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

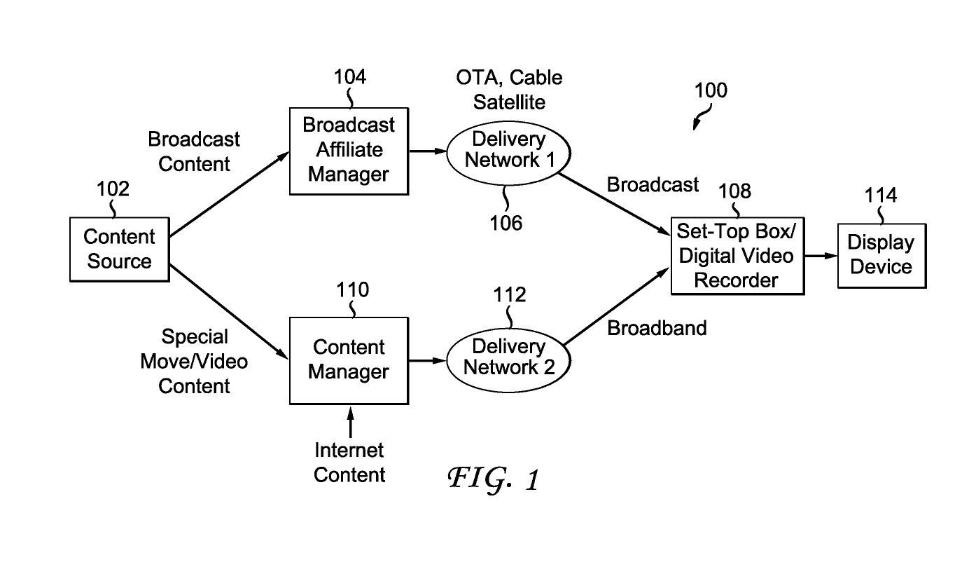

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National

Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

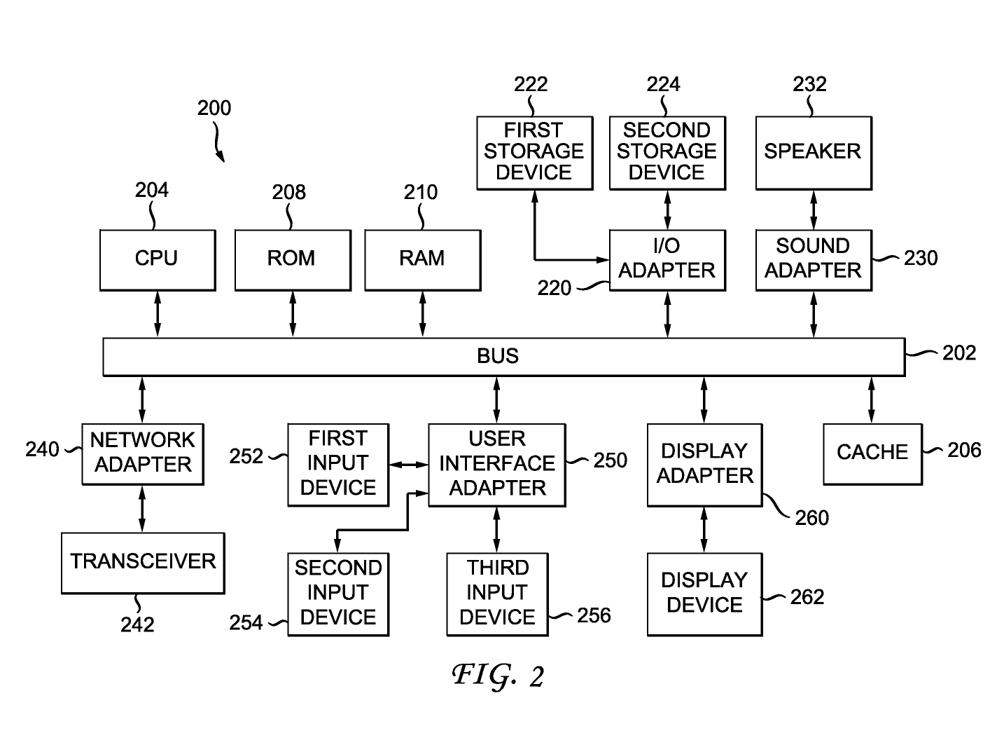

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

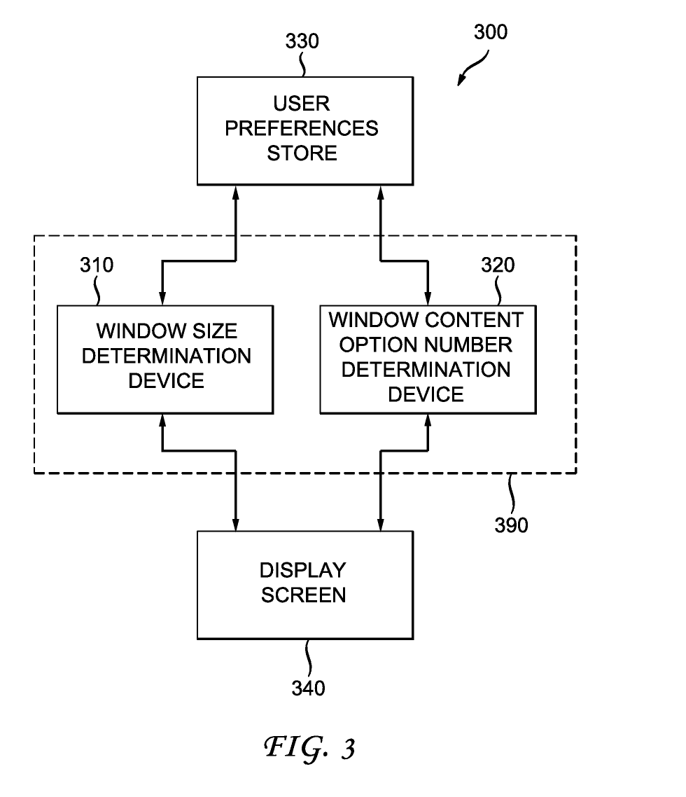

Moreover, it is to be appreciated that system 300 described below with respect to FIG. 3 is a system for implementing respective embodiments of the present principles. Part or all of processing system 200 may be implemented in one or more of the elements of system 300.

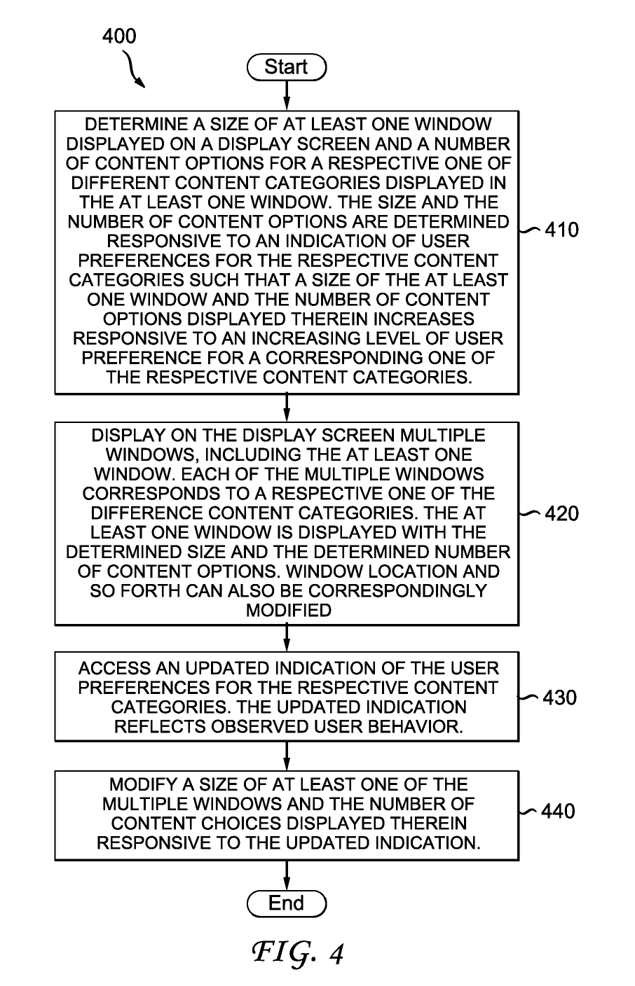

Further, it is to be appreciated that processing system 200 may perform at least part of the method described herein including, for example, at least part of method 400 of FIG. 4. Similarly, part or all of system 300 may be used to perform at least part of method 400 of FIG. 4.

FIG. 3 shows an exemplary system 300 for automatically sizing windows in response to user actions, in accordance with an embodiment of the present principles. The system 300 includes and/or otherwise involves a window size determination device 310, a window content option number determination device 320, a user preferences store 330, and a display screen 340. The window size determination device 310 and the window content option number determination device 320 may be collectively referred to herein as a window layout manager 390.

The window size determination device 310 determines the size of at least one window displayed on a display screen. In an embodiment, the window is sized such that the size of the window increases responsive to an increasing level of user preference for a corresponding one of the respective content categories and decreases responsive to a decreasing level of user preference.

The window content option number determination device 320 determines the number of content options for a respective one of different content categories displayed in the window. In an embodiment, the number of content options is determined such that the number of content options displayed in the window increases responsive to an increasing level of user preference for a corresponding one of the respective content categories and decreases responsive to a decreasing level of user preference.

The display screen 340 displays multiple windows, including the at least one window, with each of the multiple windows corresponding to a respective one of the different content categories, and the at least one window being displayed with the determined size and the determined number of content options.

The user preferences store 330 stores indications of the user preferences for the respective content categories. In an embodiment, the indications reflect observed user behavior. In an embodiment, the window size determination device 310 and the window content option number determination device 320 modify a size of windows and the number of content choices displayed therein responsive to the indications. Of course, other information can be used by the window size determination device 310 and the window content option number determination device 320 to determine window size and the number of displayed content options, while maintaining the spirit of the present principles. In an embodiment, such other information can be stored in store 330.

While the display screen 340 is shown as part of the system 300 in FIG. 3, in other embodiments the system 300 may simply interact with the display screen 340, which can be part of a different system or device (such as a content consumption or content presentation device). Moreover, in an embodiment, the entirety of system 300 is part of a content consumption or content presentation device. Further, in other embodiments, one or more of the elements of system 300 can be distributed for use by more than one content consumption or content presentation device. These and other variations of the elements of FIG. 3 are readily determined by one of ordinary skill in the art, given the teachings of the present principles provided herein, while maintaining the spirit of the present principles.

FIG. 4 shows an exemplary method 400 for automatically sizing windows in response to user actions, in accordance with an embodiment of the present principles.

At step 410, determine a size of at least one window displayed on a display screen and a number of content options for a respective one of different content categories displayed in the at least one window. The size and the number of content options are determined responsive to an indication of user preferences for the respective content categories, such that the size of the at least one window and the number of content options displayed therein increases responsive to an increasing level of user preference for a corresponding one of the respective content categories.

At step 420, display on the display screen multiple windows, including the at least one window. Each of the multiple windows corresponds to a respective one of the different content categories. The at least one window is displayed with the determined size and the determined number of content options. It is to be appreciated that step 420 can involve determining the layout of the multiple windows on the display screen. For example, for a given one of the multiple windows that is increased in size based on an increased user preference for the corresponding one of the respective content categories, a location of the window is moved to a more prominent location on the display screen.

At step 430, access an updated indication of the user preferences for the respective content categories. The updated indication reflects observed user behavior.

At step 440, modify a size of at least one of the multiple windows and the number of content choices displayed therein responsive to the updated indication.

While the updated indication can reflect observed user behavior, as noted with respect to step 430, the indication mentioned in step 410 can also reflect observed user behavior. Moreover, in an embodiment, the observed user behavior is logged in a user profile.

In an embodiment, the present principles provide a dynamic user interface that changes the look of presented windows/cards/menus in accordance with a user developed profile. In an embodiment, the present principles are directed to how a user's interaction with a digital content service provider can produce an arrangement of cards/windows that changes over time automatically. The development of a user profile is beyond the scope of the present principles. However, it is to be further appreciated that the present principles can essentially be used with any user profile, while maintaining the spirit of the present principles.

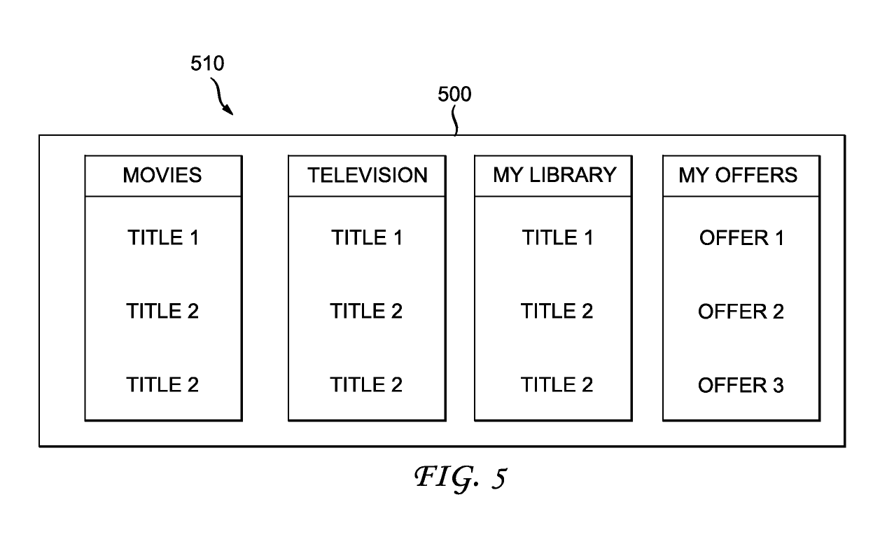

FIG. 5 shows an exemplary user interface 500 having different cards 510 depicted thereon, in accordance with an embodiment of the present principles. The different cards 510 represent topics having titles such as, but not limited to, “Movies”, “Television”, “My Library” (which is a listing of program selections a user has in their digital locker/cloud) and “My Offers”. It is to be appreciated that the preceding topics are exemplary and, thus, these and/or other topics can also be used, while maintaining the spirit of the present principles. Each card 510 has a listing of movies/television programs and offers. These respective titles and offers are denoted with labels such as “Title 1” or “Offer 1”. The arrangement of cards in FIG. 5 can represent a “new” display of cards, for example, before a user profile is developed which affects how cards/windows are to be arranged. Such cards 510 also begin with a display of 3 titles/offers, although such numbers can be adjusted in accordance with how such a system is implemented. That is, the topics, the titles, and the offers, as well as the sizes and layouts depicted in FIGS. 5-7 are for exemplary purposes and, thus, other topics, titles, offers, sizes, and layouts different than those shown herein can also be used in accordance with the present principles, while maintaining the spirit of the present principles.

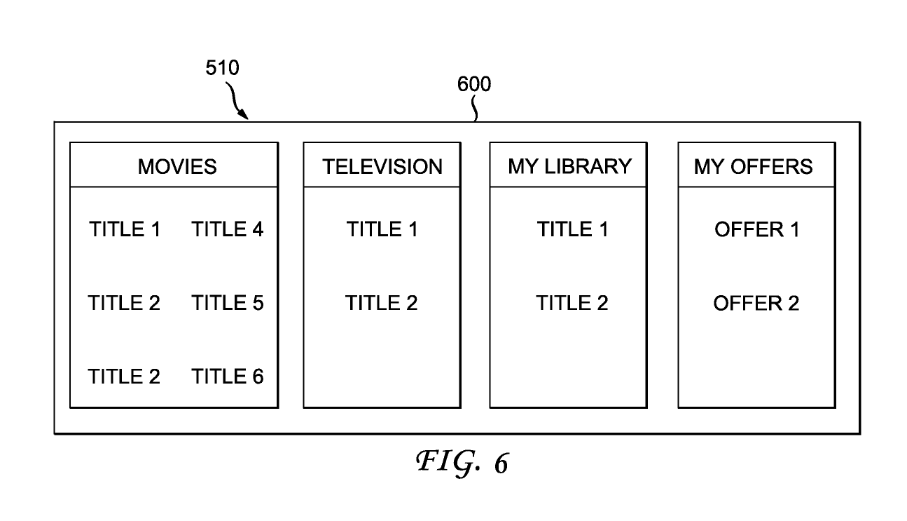

Presume for purposes of the present principles that a user interfaces with a digital content service provider in such a way where the user prefers to watch movies over watching television, playing media from their library, and/or accepting offers from the digital content service provider. This behavior can be tracked implicitly/explicitly to develop a user profile. FIG. 6 shows a modified version (hereinafter “modified user interface”) 600 of the user interface 500 of FIG. 5, in accordance with an embodiment of the present principles. The modified user interface 600 is automatically adjusted to show more movie titles (i.e., 6 movie titles on the modified user interface 600 versus 3 movie titles on the user interface 500) whereby the amount of “Television”, “My Library”, and “My Offers” is reduced (to 2 titles on the modified user interface 600 versus 3 titles on the user interface 500). In addition, the area for the more frequently used features of the digital content service provider are enlarged by modifying the size of the card (as shown by movie card) while the size of cards comporting to features that are less used are reduced (as shown by the “Television”, “My Library”, and “My Offers” cards).

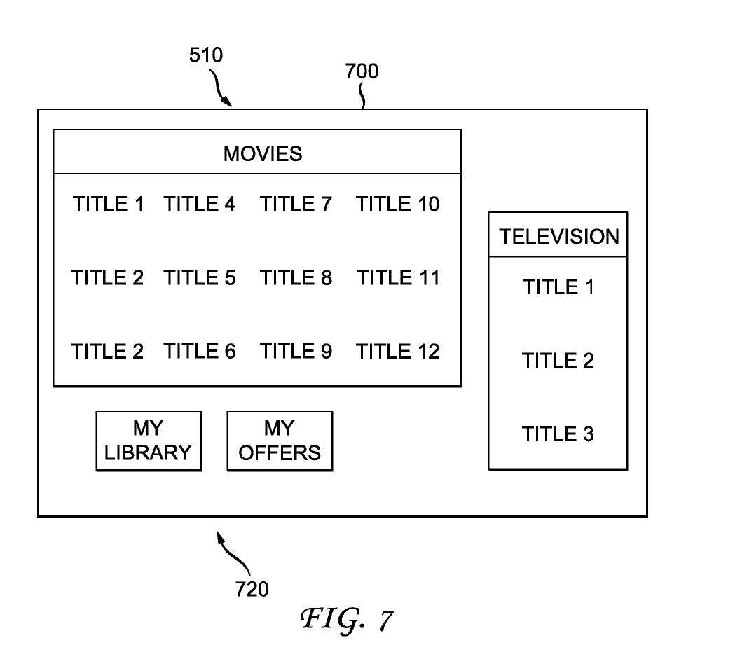

FIG. 7 shows another modified version (hereinafter “modified user interface”) 700 of the user interface 500 of FIG. 5, in accordance with an embodiment of the present principles. The modified user interface 700 shows how cards can be further modified through time where the movies card is even larger and shows 12 titles. The “Television” card still occupies some space on a screen with two titles. That is, the size (and/or location) of the cards/windows is changed to reflect the more frequent usage of movies and television services made available through the digital content service provider. The cards for “My Library” and “My Offers” end up being made into “tabs” 720 because these services are infrequently used in accordance with a user's profile. It is to be appreciated that the cards can be further adjusted as a user's profile changes in accordance with the present principles, while maintaining the spirit of the present principles.

Thus, it is to be appreciated that in accordance with various embodiments of the present principles, various parameters of multiple windows can be adjusted. Such parameters include, but are not limited to, respective sizes of the windows, respective locations of the windows, respective numbers of items included in a listing of content choices within the respective windows, a format of the windows (e.g., including a listing or being simply represented as a tab, and so forth).

We will now describe one embodiment for mapping a profile to a new window size. Of course, it is to be appreciated that the following embodiment is provided for illustrative purposes and, thus, given the teachings of the present principles provided herein, one of ordinary skill in the art will contemplate this and various other ways to map a profile to a new window size, while maintaining the spirit of the present principles. In accordance with the embodiment, a new profile for a user is initially assigned a default window size. As the user commences interacting with the user interface 500 through various functions (e.g., page surfing, clicking through, transact, play, search, and so forth), the windows is resized (e.g., in accordance with a size determined by the window size determination device 310) based upon certain criteria. In an embodiment, the criteria relates to user actions. Thus, in an embodiment, the window size determination device 310 evaluates user actions with respect to the criteria to determine a new window size for the user. Such user actions can be directed to non-window sizing functions as mentioned above (e.g., page surfing, clicking through, transact, play, search, and so forth). In this way, the user's actions can be indirectly used to determine a window size preference for the user. Of course, the present principles can be implemented to also consider user actions specifically directed to the user's window size preference.

In an embodiment, a list of various user inputs is considered. The list can be, for example, but is not limited to: a rank-ordered list; a rank-ordered weighted list; a list of the last X of that type of content, where X is an integer representing the number of times the user has selected a particular category or selection there under in a given time period; and (d) a list of content selections categorized by day/time/audience/etc. In an embodiment, the list is a rank-ordered list, where one or more of the following inputs are considered:
a. number of contents transacted upon (e.g., purchased or rented) per day, per week, per month, etc.;
b. number of clicks per page per day, per week, per month, etc.;
c. number of searches for that content, per day, per week, per month, etc.;
d. number of content reviews (e.g., a “good” from Rotten Tomatoes™), per day, per week, per month, etc.; and
e. by zip code (geography) demographics.

Of course, the preceding inputs are merely illustrative and, thus other inputs can also be used in accordance with the teachings of the present principles, while maintaining the spirit of the present principles.

The user's preferences can be quantified in any number of ways for use in resizing in accordance with the present principles. In an embodiment, the user's preferences can initially relate to default preferences, as mentioned above with respect to an initial default window size. In an embodiment, the default preferences can be determined by the product team and then business rules (the criteria) can be set up for use thereafter. In an embodiment, the business rules can be displayed in the user interface, detailing to some degree how the personalized channels (where a personalized channel is considered to involve a window of a particular size and a particular number of content options displayed therein) related thereto are determined. In an embodiment, the personalized channels are not updateable by the user, as these channels are created on the fly by the system. However, the user can be afforded the option of whether or not to subscribe to a particular channel. This and other approaches for quantifying user's preferences are readily contemplated by one of ordinary skill in the art, given the teachings of the present principles provided herein, while maintaining the spirit of the present principles.

Thus, as one envisioned embodiment, let us consider a user that watches only movies, even if of multiple genres, for a period of over three months. In such an embodiment, the “Movie” card is the only card shown to the user at that point, since the user never clicked on the other cards thus showing a disinterest in the other cards. Accordingly, the product is very “personalized” to the user's consumption, thereby making the system more efficient for the user.

A description will now be given of some of the many attendant advantages/features of the present invention, some of which have been mentioned above. For example, one advantage/feature is a method that includes determining a size of at least one window displayed on a display screen and a number of content options for a respective one of different content categories displayed in the at least one window. The size and the number of content options are determined responsive to an indication of user preferences for the respective content categories, such that the size of the at least one window and the number of content options displayed therein increases responsive to an increasing level of user preference for a corresponding one of the respective content categories. The method further includes displaying on the display screen multiple windows, including the at least one window, with each of the multiple windows corresponding to a respective one of the different content categories. The at least one window is displayed with the determined size and the determined number of content options. The method also includes accessing an updated indication of the user preferences for the respective content categories from a memory device. The updated indication reflects observed user behavior. The method additionally includes modifying a size of at least one of the multiple windows and the number of content choices displayed therein responsive to the updated indication.

Another advantage/feature is the method as described above, wherein the indication is independent of a screen layout or a device including the display screen.

Yet another advantage/feature is the method as described above, wherein for a given one of the multiple windows that is increased in size based on an increased user preference for the corresponding one of the respective content categories, a location of the window is moved to a more prominent location on the display screen.

Still another advantage/feature is the method as described above, wherein the indication also reflects prior observed user behavior with respect to the updated indication.

Moreover, another advantage/feature is the method as described above, wherein at least some of the multiple windows include a listing of content choices, the listing of content choices for the at least one window including the determined number of content options.

Further, another advantage/feature is the method wherein at least some of the multiple windows include a listing of content choices, the listing of content choices for the at least one window including the determined number of content options as described above, and wherein the method includes changing at least a given one of the multiple windows to a tab having an absence of the listing of content choices responsive to an indication or an updated indication of the user preferences for a given one of the content categories associated with the given one of the multiple windows.

Also, another advantage/feature is the method as described above, wherein at least one of the indication of user preferences and the updated indication of user preferences include at least one of a number of contents transacted upon in a given time period, a number of clicks per content page in the given time period, a number of searches for a particular one of the content categories in the given time period, a number of contents reviewed in the given time period, and user geography demographics.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
determining a size of at least one window displayed on a display screen and a number of content options for a respective one of different content categories displayed in the at least one window, the size and the number of content options being determined responsive to an indication of user preferences for the respective content categories, such that the size of the at least one window and the number of content options displayed therein increases responsive to an increasing level of user preference for a corresponding one of the respective content categories;
displaying on the display screen multiple windows, including the at least one window, with each of the multiple windows corresponding to a respective one of the different content categories, and the at least one window being displayed with the determined size and the determined number of content options;
accessing an updated indication of the user preferences for the respective content categories from a memory device, the updated indication reflecting observed user behavior; and
modifying a size of at least one of the multiple windows and the number of content choices displayed therein responsive to the updated indication.

2. The method of claim 1, wherein the indication is independent of a screen layout or a device comprising the display screen.

3. The method of claim 1, wherein for a given one of the multiple windows that is increased in size based on an increased user preference for the corresponding one of the respective content categories, a location of the window is moved to a more prominent location on the display screen.

4. The method of claim 1, wherein the indication also reflects prior observed user behavior with respect to the updated indication.

5. The method of claim 1, wherein at least some of the multiple windows include a listing of content choices, the listing of content choices for the at least one window including the determined number of content options.

6. The method of claim 5, further comprising changing at least a given one of the multiple windows to a tab having an absence of the listing of content choices responsive to an indication or an updated indication of the user preferences for a given one of the content categories associated with the given one of the multiple windows.

7. The method of claim 1, wherein at least one of the indication of user preferences and the updated indication of user preferences comprise at least one of a number of contents transacted upon in a given time period, a number of clicks per content page in the given time period, a number of searches for a particular one of the content categories in the given time period, a number of contents reviewed in the given time period, and user geography demographics.

8. A system in a media presentation device, comprising:
a window layout manager for determining a size of at least one window and a number of content options for a respective one of different content categories displayed in the at least one window, the size and the number of content options being determined responsive to an indication of user preferences for the respective content categories, such that the size of the at least one window and the number of content options displayed therein increases responsive to an increasing level of user preference for a corresponding one of the respective content categories; and
a display screen for displaying multiple windows, including the at least one window, with each of the multiple windows corresponding to a respective one of the different content categories, and the at least one window being displayed with the determined size and the determined number of content options,
wherein the window layout manager accesses an updated indication of the user preferences for the respective content categories, and modifies a size of at least one of the multiple windows and the number of content choices displayed therein responsive to the updated indication, the updated indication reflecting observed user behavior.

9. The system of claim 8, wherein the indication is independent of a screen layout or a device comprising the display screen.

10. The system of claim 8, wherein for a given one of the multiple windows that is increased in size based on an increased user preference for the corresponding one of the respective content categories, a location of the window is moved to a more prominent location on the display screen.

11. The system of claim 8, wherein the indication also reflects prior observed user behavior with respect to the updated indication.

12. The system of claim 8, wherein at least some of the multiple windows include a listing of content choices, the listing of content choices for the at least one window including the determined number of content options.

13. The system of claim 12, wherein the window layout manager changes at least a given one of the multiple windows to a tab having an absence of the listing of content choices responsive to an indication or an updated indication of the user preferences for a given one of the content categories associated with the given one of the multiple windows.

14. The system of claim 8, wherein at least one of the indication of user preferences and the updated indication of user preferences comprise at least one of a number of contents transacted upon in a given time period, a number of clicks per content page in the given time period, a number of searches for a particular one of the content categories in the given time period, a number of contents reviewed in the given time period, and user geography demographics.

15. A non-transitory computer readable storage medium having computer executable code stored thereon for performing a method, the method comprising:
determining a size of at least one window displayed on a display screen and a number of content options for a respective one of different content categories displayed in the at least one window, the size and the number of content options being determined responsive to an indication of user preferences for the respective content categories, such that the size of the at least one window and the number of content options displayed therein increases responsive to an increasing level of user preference for a corresponding one of the respective content categories;
displaying on the display screen multiple windows, including the at least one window, with each of the multiple windows corresponding to a respective one of the different content categories, and the at least one window being displayed with the determined size and the determined number of content options;
accessing an updated indication of the user preferences for the respective content categories from a memory device, the updated indication reflecting observed user behavior; and
modifying a size of at least one of the multiple windows and the number of content choices displayed therein responsive to the updated indication.
